(19) United States
(12) Patent Application Publication
(10) Pub. No.: US 2007/0190394 A1
(43) Pub. Date: Aug. 16, 2007

(54) Fuel cell

(76) Inventors: Hiroki Kabumoto, Saiama-Shi (JP); Takashi Yasuo, Ashikaga-Shi (JP)

Correspondence Address: MCDERMOTT WILL & EMERY LLP, 600 13TH STREET, N.W., WASHINGTON, DC, 20005-3096, US

(21) Appl. No.: 11/643,930

(22) Filed: Dec. 22, 2006

(30) Foreign Application Priority Data
Dec. 22, 2005 (JP) 2005-369886
Mar. 27, 2006 (JP) 2006-084841

(51) Int. Cl. H01M 8/02; H01M 2/08

(52) U.S. Cl. 429/38; 429/34; 429/35

(57) ABSTRACT

A fuel cell is provided for which it is not necessary to give consideration to the direction of installation. The fuel cell includes: an electrolyte layer; a first electrode provided on a first main surface of the electrolyte layer; a second electrode provided on a second main surface of the electrolyte layer; a casing which houses the electrolyte layer, the first electrode and the second electrode; a first reaction product fluid discharge opening provided in the casing; and a second reaction fluid feed opening provided in the casing. The first reaction product discharge opening is provided on at least two surfaces of the casing. Or, the reaction product discharge openings are provided on a surface on which the second reaction fluid feeding opening is provided.

### BACKGROUND OF THE INVENTION

1. Field of the Invention

The present invention relates to a fuel cell and, more particularly, to a fuel cell, for use with mobile equipment, whose direction of installation does not require any particular attention.

2. Description of the Related Art

A fuel cell is a device that generates electricity from hydrogen and oxygen so as to obtain highly efficient power generation. A principal feature of a fuel cell is its capacity for direct power generation which does not undergo a stage of thermal energy or kinetic energy as in conventional power generation. This presents such advantages as high power generation efficiency despite the small scale setup, reduced emission of nitrogen compounds and the like, and environmental friendliness on account of minimal noise or vibration. A fuel cell is capable of efficiently utilizing chemical energy in its fuel and, as such, environmentally friendly. Fuel cells are therefore envisaged as an energy supply system for the twenty-first century and have gained attention as a promising power generation system that can be used in a variety of applications including space applications, automobiles, mobile devices, and large and small scale power generation. Serious technical efforts are being made to develop practical fuel cells.

Of various types of fuel cells, a polymer electrolyte fuel cell excels in its low operating temperature and high output density. Recently, direct methanol fuel cells (DMFC) are especially attracting the attention as a type of polymer electrolyte fuel cell. In a DMFC, methanol water solution as a fuel is not reformed and is directly supplied to the anode so that electricity is produced by an electrochemical reaction induced between the methanol water solution and oxygen. Discharged as reaction products resulting from the electrochemical reaction are carbon dioxide emitted from the anode and generated water is emitted from the cathode. Methanol water solution has a higher energy density per unit volume than hydrogen. Moreover, it is suitable for storage and poses little danger of explosion. Accordingly, it is expected that methanol water solution will be used in power supplies for automobiles, mobile devices (cell phones, notebook personal computers, PDAs, MP3 players, digital cameras, electronic dictionaries and books) and the like.

Related Art List

(1) Japanese Patent Application Laid-Open No. 2005-100839.

Planar-shaped fuel cells, such as disclosed in Reference (1), are expected to find wider use in mobile equipment that are required to be small-size and lightweight, but present a problem that if the anode is formed on the main surface on the underside of the electrolyte layer, carbon dioxide, which is the reaction product from the anode, may stay on in the anode, thus causing a drop in reaction efficiency.

### SUMMARY OF THE INVENTION

The present invention has been made in view of the foregoing circumstances, and a general purpose thereof is to provide a fuel cell, for use with mobile equipment, for which it is not necessary to give consideration to the direction of installation.

In order to achieve the above purpose, a fuel cell according to one embodiment of the present invention comprises: an electrolyte layer; a first electrode, provided on a first main surface of the electrolyte layer, in which a first liquid reaction fluid is supplied and a first gaseous reaction product is produced; a second electrode, provided on a second main surface of the electrolyte layer, in which a second reaction fluid is supplied; a casing which houses the electrolyte layer, the first electrode and the second electrode; a first reaction product fluid discharge opening, provided in the casing, which discharges the first reaction product from the first electrode; and a second reaction fluid feed opening, provided in the casing, which supplies the second fluid reaction fluid to the second electrode, wherein the first reaction product discharge opening is provided on at least two surfaces of the casing. Or, in the same fuel cell, the first reaction product discharge opening is provided on the surface on which the second reaction fluid feed opening is provided.

Here, conceivable as the first liquid reaction fluid are alcohols containing methanol and their water solutions, or material like formic acid, whereas conceivable as the first gaseous reaction product is carbon dioxide or the like. On the other hand, generally considered as the second reaction fluid is air (oxygen in the air) in terms of the earth's environment, or oxygen, hydrogen peroxide supplied from an oxygen tank or the like in terms of environment like in a rocket or submarine.

In a fuel cell utilizing such reacting fluids, the first reaction product discharge opening is provided on at least two surfaces of the casing. As a result, even if a user places the fuel cell in such a manner as to block a surface on which the first reaction production discharge opening is provided, the first reaction product can be discharged from other surface, so as to prevent the case where the first reaction product remains in the first electrode and the reaction efficiency of the fuel cell is reduced. Also, the user of this fuel cell can use the fuel cell without giving consideration to the direction of installation. Moreover, the first reaction product discharge opening is provided on the same surface as one on which the second reaction fluid feed opening. As a result, even if the user places the fuel cell in such a manner as to block a surface on which the second reaction fluid feed opening of the casing, the second reaction fluid will not be supplied to the fuel cell, so that the electric power is not generate and no first reaction product is generated. Hence, the user of this fuel cell can use the fuel cell without giving consideration to the direction of installation.

In the fuel cell according to the above embodiment, a material having gas permeability and liquid impermeability is placed in the first reaction product discharge opening. Here, the material having a gas permeation property and a liquid impermeability property is a material such that the gaseous components are selectively passed therethrough but the liquid components are not passed therethrough. The material suited thereto may be a planar filter having minute porosity formed of a fluororesin such as polytetrafluoroethylene. Thereby, in addition to the aforementioned advantageous effects, the gaseous reaction products only can be discharged to the outside of the fuel cell and the liquid reaction fluids can be held within the fuel cell.

In the fuel cell according to the above embodiment, the fuel cell may further comprise a first reaction fluid chamber which holds the first reaction fluid, wherein at least two surfaces countered to each other have an approximately parallel form. In this fuel cell, there may be provided a recess in one of the at least two surfaces of the first reaction fluid chamber, and the recess houses the first electrode and said second electrode, and wherein one of the surfaces of the first reaction fluid chamber and a surface on which said second reaction fluid feed opening in the casing is provided form an identical surface. Here, the form in which “at least two surfaces countered to each other have an approximately parallel form” may be a rectangular parallelepiped (cube), a cylinder, or one with the corner or side thereof being chamfered, or may be one having two approximately parallel surfaces wherein the tolerance is such that the inclination is less than 10 degrees in the light of usability and design. There is provided a recess in one of the surfaces and a so-called MEA is fit into this recess. And a structure is such that one of the surfaces of the first reaction fluid chamber and a surface, on which the second reaction fluid feed opening, form an identical surface. As a result, the volume of the first reaction fluid chamber can be made as large as practicable in the light of designing a small-sized fuel cell and, in addition to the advantageous effects gained by the fuel cell according to any one of claim 1 to claim 4, a longer period of electric power generation is possible.

It is to be noted that any arbitrary combinations or rearrangement, as appropriate, of the aforementioned constituting elements and so forth are all effective as and encompassed by the embodiments of the present invention.

Moreover, this summary of the invention does not necessarily describe all necessary features so that the invention may also be sub-combination of these described features.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 is a perspective view schematically showing the appearance of a fuel cell according to a first embodiment of the present invention;

FIG. 2 is an exploded perspective view of a fuel cell, with a casing on an anode side removed, according to a first embodiment of the present invention;

FIG. 3 is a cross-sectional view schematically showing an internal structure of a fuel cell according to Example 1 of the first embodiment;

FIG. 4 is a cross-sectional view schematically showing an internal structure of a fuel cell according to Example 2 of the first embodiment;

FIG. 5 is a perspective view schematically illustrating an appearance of a fuel cell according to Example 3 of the first embodiment as applied to a notebook-sized personal computer;

FIG. 6 is a cross-sectional view schematically illustrating an internal structure of a fuel cell according to Example 3 of the first embodiment;

FIGS. 7A and 7B are cross-sectional views schematically illustrating internal structures of a fuel cell according to Example 3 of the first embodiment;

FIG. 8 is a perspective view schematically illustrating an appearance of a fuel cell according to Example 4 of the first embodiment as applied to a mobile phone;

FIG. 9 is a cross-sectional view schematically illustrating an internal structure of a fuel cell according to Example 4 of the first embodiment;

FIG. 10 is an exploded perspective view showing a DMFC according to Example 1 of a second embodiment;

FIG. 11 illustrates a structure in an anode side of an electrolyte membrane according to Example 1 of the second embodiment;

FIG. 12 is a cross-sectional view, taken along the line A-A of FIG. 10, showing a structure of a DMFC according to Example 1 of the second embodiment;

FIG. 13 is a cross-sectional view showing a structure of a DMFC according to Example 2 of the second embodiment;

FIG. 14 is a perspective view of an anode-side gasket used in Example 3 of the second embodiment;

FIG. 15 is a perspective view of an anode-side gasket used in Example 4 of the second embodiment;

FIG. 16 illustrates an example where a DMFC according to Example 4 of the second embodiment is placed on the back face of a fold-type mobile phone;

FIG. 17 is a cross-sectional view taken along the line B-B of FIG. 16;

FIG. 18 is a cross-sectional view taken along the line C-C of FIG. 16; and

FIG. 19 illustrates an example where a DMFC according to Example 4 of the second embodiment is placed on the backside of LCD of a fold-type mobile phone.

### DETAILED DESCRIPTION OF THE INVENTION

The invention will now be described by reference to the preferred embodiments. This does not intend to limit the scope of the present invention, but to exemplify the invention.

### First Embodiment

The basic structure of a fuel cell 50 according to a first embodiment will now be described with reference to the accompanying drawings.

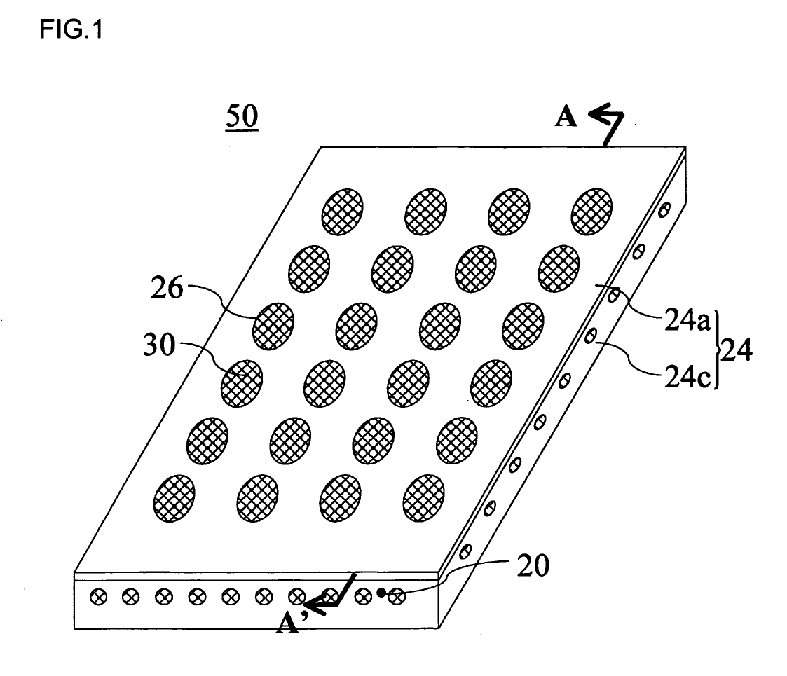

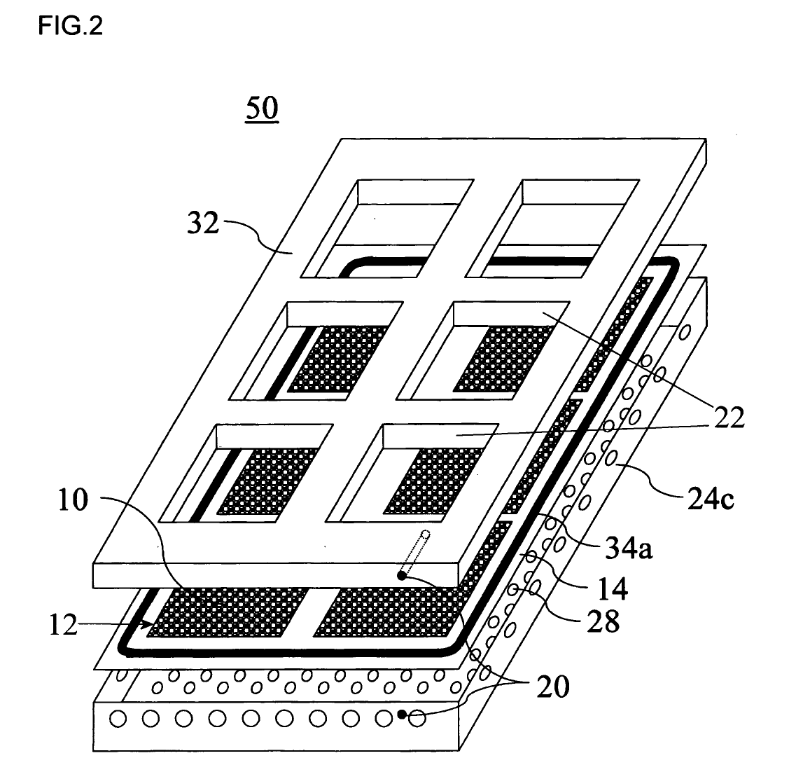

FIG. 1 is a perspective view schematically showing the appearance of a fuel cell 50 according to the first embodiment. FIG. 2 is an exploded perspective view of a fuel cell 50 with a casing 24a on the anode side removed. The fuel cell 50 in the present embodiment is a DMFC (Direct Methanol Fuel Cell) in which a methanol aqueous solution or pure methanol (hereinafter referred to as “methanol fuel”) is supplied to anodes 10. A membrane-electrode assembly (MEA) 12, which is a power generating unit, is formed in such a manner that an electrolyte membrane 14 is held between an anode 10 and a cathode (not shown).

The methanol fuel to be supplied to the anode 10 is supplied to a fuel chamber 22 through a methanol fuel feeding hole 20 from the outside of the fuel cell 50. The fuel chambers 22 are interconnected with one another, and the methanol fuel stored in the respective fuel chambers 22 is supplied to the respective anodes 10. At the anodes 10, a reaction of methanol as expressed in the following formula (1) takes place, in which H⁺ moves to the cathodes by way of the electrolyte membrane 14 and at the same time electric power is outputted.
CH₃OH+H₂O→CO₂+6H⁺+6e⁻ (1)

As is apparent from formula (1), carbon dioxide is generated from the anode 10 in this reaction. Accordingly, a gas-liquid separation filter 30 is disposed between each fuel chamber 22 and an anode-side product discharge hole 26 provided in the casing 24a on the anode side of the fuel cell 50.

This gas-liquid separation filter 30 is a planar filter having minute porosity that selectively has the gas component pass through but does not have the liquid component pass through. The material suited to this gas-liquid separation filter 30 is any of a variety of fluororesins with high methanol (alcohol) resistance, which include polyhchloro-trifluoroethylene, polyvinylidene-fluoride, polyvinyl fluoride, tetrafluoroethylene-ethylene copolymer, polytetrafluoroethylene (PTFE), tetrafluoroethylene-perfluoroalkylvinylether copolymer (PFA), tetrafluoroethylene-hexafluoropropylene copolymer (FEP), tetrafluoroethylene-ethylene copolymer (E/TFE), polyvinylidene fluoride (PVDF), polychlorotrifluoroethylene (PCTFE), chlorotrifluoroethylene-ethylene copolymer (E/CTFE), perfluoro ring polymer, and polyvinyl fluoride (PVF).

The material suitable for the casing 24 is preferably one featuring light weight, rigidity and corrosion resistance. Such materials include a certain variety of synthetic resins, such as acrylic resin, epoxy resin, glass-epoxy resin, silicon resin, cellulose, nylon, polyamide-imide, polyallylamide, polyallyl ether ketone, polyimide, polyurethane, polyetherimide, polyether ether ketone, polyether ketone ether ketone ketone, polyether ketone ketone, polyether sulfone, polyethylene, polyethylene glycol, polyethylene terephthalate, polyvinyl chloride, polyoxymethylene, polycarbonate, polyglycolic acid, polydimethylsiloxane, polystyrene, polysulfone, polyvinyl alcohol, polyvinyl pyrrolidone, polyphenylene sulfide, polyphthalamide, polybutylene terephthalate, polypropylene, polytetrafluoroethylene, and rigid polyvinyl chloride as well as such metals as aluminum alloy, titanium alloy and stainless steel. Such materials may also be reinforced glass and skeleton resin. And the casing 24, which, as with the gas-liquid separation filter 30, has parts coming in contact with the methanol fuel, may be made of a compound material, comprised of a fluororesin overlapping any of the above-listed synthetic resins or metals, especially in parts that will come in contact with the methanol fuel. A support member 32, which functions to form the fuel chambers 22 and at the same time secure the MEA 12, may be preferably made of the same material as that for the parts of the casing 24 that will come in contact with the methanol fuel.

In this first embodiment, the MEA 12 is of such design that the electrolyte membrane 14 is made of DuPont's Nafion 115, and an anode 10 is formed on one face of the electrolyte membrane 14 by applying an anode catalyst paste, which is a mixture of Pt—Ru black and a 5 wt % solution of DuPont's Nafion whereas a cathode 16 is formed on the other face thereof by applying a cathode catalyst paste, which is a mixture of Pt black and a 5 wt % solution of DuPont's Nafion. Note that Nafion is a trademark registered by DuPont. In this first embodiment, the material used for the electrolyte membrane 14 is Nafion 115, but it may be any if it can form an ion-conducting electrolyte membrane of 50 to 200 μm in thickness. In the case of a DMFC using a methanol fuel as the fuel as in the present embodiment, it is more preferable if such a material can form an electrolyte membrane capable of controlling a phenomenon called “cross-leak” in which methanol moves over to the cathode side by passing through the electrolyte membrane 14. The method employed in this embodiment is such that the anode 10 and the cathode 16 are formed on the respective faces of the electrolyte membrane 14, but the manufacturing method therefor may be of such structure and method that the catalyst layers are formed on an electrode substrate such as carbon paper. Moreover, instead of the particles composed of Pt—Ru or Pt (e.g., Pt—Ru black or Pt black), a catalyst-supported carbon, which supports the catalyst in carbon, may be used as the catalyst so long as it has a catalytic function of generating H⁺ from methanol or water from H⁺ and oxygen.

Air is supplied to the cathode 16 through cathode-side product discharge holes 28, and the generated water is generated by a reaction as expressed in the following formula (2) that takes place between H⁺ having reached the cathode 16 through the electrolyte membrane 14 and oxygen in the air.

$$\frac{3}{2} {O}_{2} + 6 {H}^{+} + 6 {e}^{-} \to 3 {H}_{2} O \qquad ( 2 )$$

The cathode-side product discharge holes 28, which not only supply air to the cathode 16 but also discharge generated water from the cathode 16, have a total area equal to that of anode-side product discharge holes 26, but have a larger number of holes smaller in diameter than the anode-side product discharge holes 26. The inner walls of the cathode-side product discharge holes 28 and the surface of a casing 24b on the cathode side of the part where the cathode-side product discharge holes 28 are provided are coated with a functional coating material, including photocatalyst, such as oxidized titanium. Provision of many small holes prevents the generated water discharged from the cathode 16 from dripping, and coating of the inner walls with a functional coating material makes it easier for the generated water to spread thinly over the surface of the inner walls and evaporate without clogging the holes and also prevents the breeding of microorganisms and the like there. It is preferable that this functional coating material contains such metal as silver, copper, or zinc so that the organics-decomposition or antimicrobial function thereof works even when the fuel cell 50 is not exposed to the irradiation of sunlight or other light containing specific wavelengths that trigger photocatalysis. Moreover, coating of the functional coating material on the whole surface of the casing 24 may provide the fuel cell 50 with a contamination-free function or antimicrobial function which will decompose the organic matter adhering thereto from the touches of the user of the fuel cell 50.

O-rings 34 (an anode-side O-ring 34a and a cathode-side O-ring 34c) are disposed in such a manner as to enclose a plurality of MEAs 12 in order to prevent the methanol fuel from flowing into the cathode 16 from the anode 10. In the present embodiment, they are pressed by a cathode-side casing 24c and a support member 32 so as to not only prevent the methanol fuel from flowing into the cathode 16 from the anode 10 but also prevent oxygen from flowing into the anode 10. It is preferable for these O-rings 34 to have flexibility and corrosion resistance, and the material suitable therefor is, for example, natural rubber, nitrile rubber, acrylic rubber, urethane rubber, silicon rubber, butadiene rubber, styrene rubber, butyl rubber, ethylene-propylene rubber, fluoro-rubber, chloroprene rubber, isobutylene rubber, acrylonitrile rubber, and acrylonitrile-butadiene rubber.

In addition to the above structure, a porous Teflon (registered trademark) sheet (not shown) capable of circulating air and generated water may be inserted between the cathode 16 and the cathode-side casing 24c to prevent the user from coming into contact with the cathode 16. Or it is also possible to use casing design such that the user, when or if he/she touches the surface of the casing 24 of the fuel cell 50, may not come into contact with the cathode 16, with adjustments made to the diameter of the cathode-side product discharge holes 28 and the thickness of the part of the casing 24 where the cathode-side product discharge holes 28 are provided (the thickness of the casing 24 increased in relation to the diameter of the cathode-side product discharge holes 28). Further, if a lid covering the part where the cathode-side product discharge holes 28 are provided is added, then it is possible to prevent the MEA 12, and the electrolyte membrane 14 in particular, from getting dry during the stoppage of the fuel cell 50 and also prevent dust or organic matter such as bacteria (fungi) from entering the cathode 16 side. This lid, if it is a sliding type, may be provided without taking much space.

In the first embodiment, a fuel chamber 22 has been described as a space filled with a methanol fuel. However, a three-dimensional porous material like sponge which absorbs the methanol fuel (a fuel absorbent) may be inserted in the fuel chamber 22. Such a fuel absorber may be a woven fabric, nonwoven fabric, or felt of such fibers as nylon, polyester, rayon, cotton, polyester/rayon, polyester/acryl, or rayon/polychlal. A fuel absorbent inserted in the fuel chamber 22 causes a capillary phenomenon, which makes it possible to supply methanol fuel evenly to the anode irrespective of the direction (position) of installation of the fuel cell 50. Further, in the present embodiment, a description has been given of an example of coating a functional coating material capable of photocatalysis on the casing 24. However, it should be appreciated that at least an antimicrobial function can be secured by simply coating such metal as silver, copper or zinc on the surface of the casing 24 or mixing such metal as silver, copper or zinc into the material forming the casing 24.

### EXAMPLE 1 OF THE FIRST EMBODIMENT

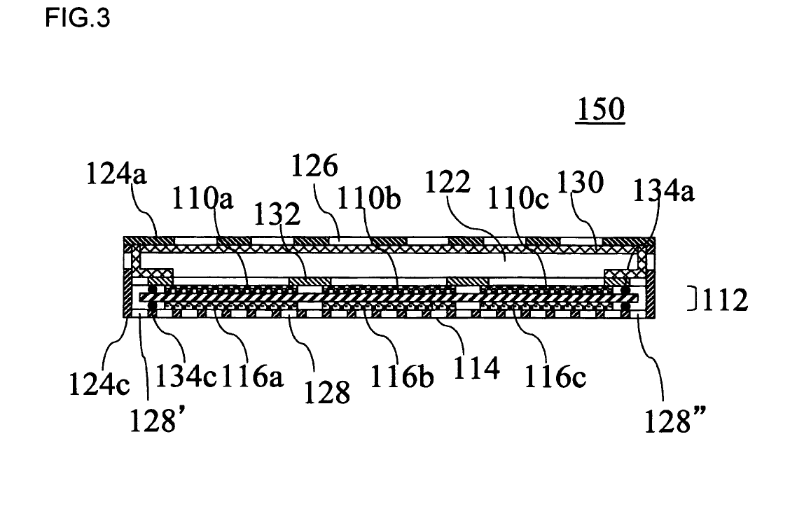

FIG. 3 is a cross-sectional view, taken along the line A-A′ of FIG. 1, which schematically illustrates an internal structure of a fuel cell 150 according to Example 1 of the first embodiment. According to this embodiment, disposed on a single electrolyte membrane 114 are a plurality of anodes 110 (110a, 110b, 110c, . . . ) and a plurality of cathodes 116 (116a, 116b, 116c, . . . ) arranged counter thereto. And MEAs 112 are connected in series by connecting the anode 110a to the cathode 116b, for instance, by a not-shown wiring.

A characteristic feature of this example lies in the point that the anode-side product discharge holes 126 are provided not only in positions of the anode-side casing 124a countered to the anodes 110 via the fuel chamber 122 but also in the side of the casing 124 and in the support member 132. All the anode-side product discharge holes 126 are provided with a gas-liquid separation filter 130, and as previously described, the gaseous component, such as carbon dioxide, generated from the anode 110 can be selectively passed through the gas-liquid separation filter 130 before being discharged while the liquid component, such as the methanol fuel is not passed therethrough and held in the fuel chamber 122. With anode-side product discharge holes 126 provided in the support member 132 and with cathode-side product discharge holes 128 provided in the area of the cathode-side casing 124c outside of the cathode-side O-ring 134c as shown in FIG. 3, the cathode-side product holes 128′ and 128″ in particular play the role of discharging the gaseous component arising from the anode 110.

By implementing the structure as described above, the reaction products and the like from the anodes 110 can be discharged without their remaining in the anodes 110 or the fuel chamber 122 whether the fuel cell 150 is so positioned that the anodes 110 are located on the top surface of the electrolyte membrane 114 or the cathodes 116 are located on the top surface thereof. Further, provision of anode-side product discharge holes 126 also in the side of the casing 124 ensures that the reaction products and the like from the anodes 110 can be discharged without their remaining in the anodes 110 or the fuel chamber 122 even when the fuel cell 150 is so positioned that the electrolyte membrane 114 takes a perpendicular position. Hence, the fuel cell 150 according to this example does not require any particular attention to the direction of its installation.

In addition to the above, a housing may be provided outside the casing 124 (the anode-side casing 124a in particular) so that the reaction products discharged from the anode-side product discharge holes 126 may be discharged out of the housing through fluid passage holes provided in the housing. Provision of a housing outside the casing 124 may improve the strength of the fuel cell 150, and provision of a gas-liquid separation filter for the fluid passage holes may more effectively prevent the leak of methanol fuel from the fuel chamber 122. Also, provision of fluid passage holes on the side of the cathode-side product discharge holes 128 may cause an agitation of air near the cathode-side product discharge holes 128 by the discharge flow of the reaction products, thus making it easier to supply air to the cathodes 116.

### EXAMPLE 2 OF THE FIRST EMBODIMENT

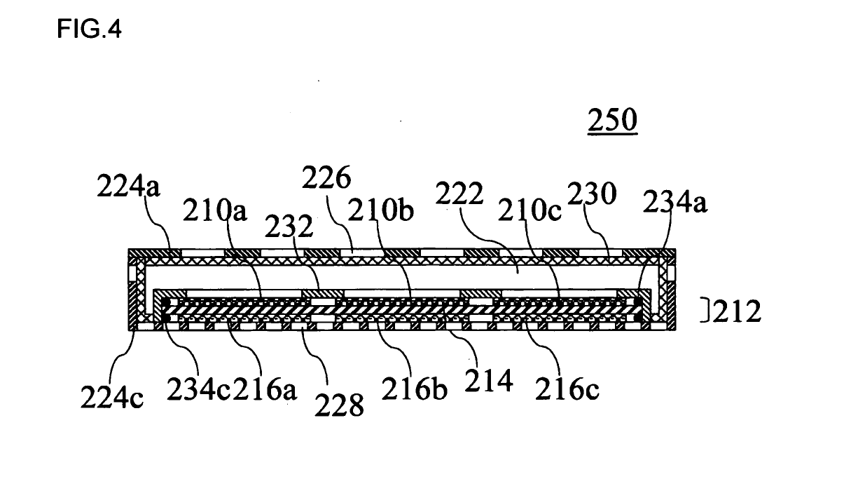

FIG. 4 is a cross-sectional view, taken along the line A-A′ of FIG. 1, which schematically illustrates an internal structure of a fuel cell 250 according to Example 2 of the first embodiment. According to this example, too, disposed on a single electrolyte membrane 214 are a plurality of anodes 210 (210a, 210b, 210c, . . . ) and a plurality of cathodes 216 (216a, 216b, 216c, . . . ) arranged counter thereto. And MEAs 212 are connected in series by connecting the anode 210a to the cathode 216b, for instance, by a not-shown wiring or the like.

A characteristic feature of this example lies in the point that a fuel chamber 222 is provided in a U shape cross-sectionally in such a manner as to enclose the MEA 212 and that the anode-side product discharge holes 226 are provided not only in positions of the anode-side casing 224a in opposition to the anodes 210 via the fuel chamber 222 but also in the side of a casing 224 and in the same surface as cathode-side product discharge holes 228. All the anode-side product discharge holes 226 are provided with a gas-liquid separation filter 230, and as with Example 1, the gaseous component, such as carbon dioxide, generated from the anode 210 can be selectively passed through the gas-liquid separation filter 230 before being discharged while the liquid component, such as the methanol fuel, is not passed therethrough and held in the fuel chamber 222.

By implementing the structure as described above, the reaction products and the like from the anodes 210 can be discharged without their remaining in the anodes 210 or the fuel chamber 222 whether the fuel cell 250 is so positioned that the anodes 210 are located on the top surface of the electrolyte membrane 214 or the cathodes 216 are located on the top surface thereof or even when the fuel cell 250 is so positioned that the electrolyte membrane 214 takes a perpendicular position. Hence, the fuel cell 250 according to the present embodiment does not require any particular attention to the direction of its installation. Moreover, the fuel cell 250 may have a longer operation time because the fuel chamber 222 has a capacity larger by the added portion of the fuel chamber 222 enclosing the MEA 212.

### EXAMPLE 3 OF THE FIRST EMBODIMENT

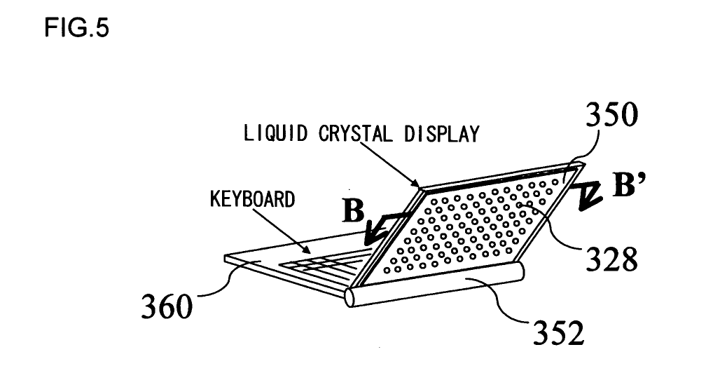

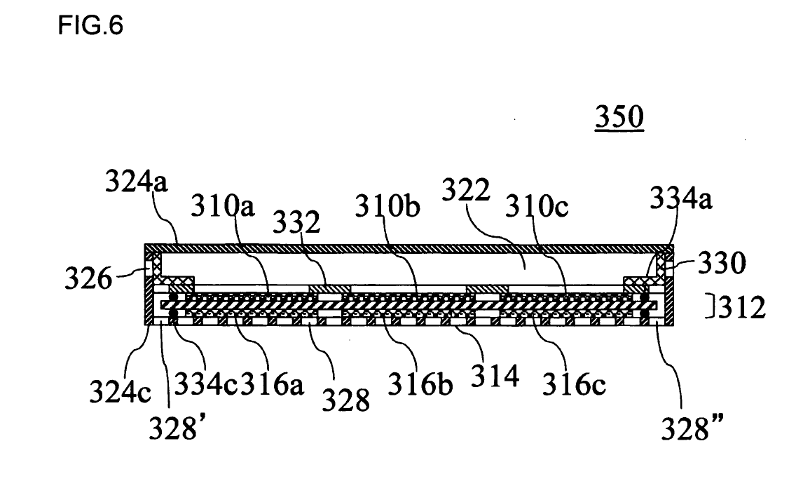

FIG. 5 is a perspective view schematically illustrating an appearance of a fuel cell 350 according to Example 3 of the first embodiment as applied to a notebook-sized personal computer (notebook-sized PC) 360. In this example, a methanol fuel to be supplied to the anodes 310 is fed to the fuel chamber 322 through a methanol fuel feeding hole 320 from a fuel cartridge 352 provided on one side of the fuel cell 350. According to this example, anode-side product discharge holes as in the first and second examples are not provided in the casing 324 (main surface of the casing 324a in particular), and the openings provided in the casing 324 are cathode-side product discharge holes 328 only. FIG. 6 is a cross-sectional view, taken along the line B-B′ of FIG. 5, which schematically illustrates an internal structure of a fuel cell 350 according to Example 3. According to this Example, too, disposed on a single electrolyte membrane 314 are a plurality of anodes 310 (310a, 310b, 310c, . . . ) and a plurality of cathodes 316 (316a, 316b, 316c, . . . ) arranged counter thereto. And MEAs 312 are connected in series by connecting the anode 310a to the cathode 316b, for instance, by a not-shown wiring or the like.

A characteristic feature of this example lies in the point that the anode-side product discharge holes 326 are not provided in positions of the anode-side casing 324a in opposition to the anodes 310 via the fuel chamber 322 as described previously. The anode-side product discharge holes 326 are provided in the support member 332 and in the side of the casing 324, depending on the height dimension of the fuel chamber 322. And all the anode-side product discharge holes 326 are provided with a gas-liquid separation filter 330, and the gaseous components, such as carbon dioxide, generated from the anodes 310 are selectively discharged while the liquid components, such as the methanol fuel are held in the fuel chamber 322. As with Example 1, cathode-side product discharge holes 328 are provided in the area of the cathode-side casing 324c outside of the cathode-side O-ring 334c, so that the cathode-side product holes 328′ and 328″ in particular play the role of discharging the gaseous components arising from the anodes. In this arrangement, the leak of methanol fuel from the fuel chamber 322 will be effectively prevented if the discharge paths of gaseous components arising from the anodes 310, such as the cathode-side product holes 328′ and 328″, are filled with some metallic catalyst active in the oxidation of the fuel or some material, such as activated carbon, zeolite, sepiolite or mordenite, capable of removing or adsorbing the fuel vapor.

By implementing the structure as described above, the reaction products from the anodes 310 are discharged through the cathode-side product discharge holes 328, so that even when a main surface of the fuel cell 350 is blocked up by an application for supplying electrical power generated by the fuel cell 350, such as a notebook-sized PC 360, the oxidant (air) is supplied to the cathodes 316 and at the same time the reaction products from the anodes 310 and the cathodes 316 can be discharged. And when the cathode-side product discharge holes 328 are also blocked up, the fuel cell 350 cannot generate power without the supply of the oxidant to the cathodes 316, and therefore there is no need to discharge any reaction products from the anodes 310 and the cathodes 316. Hence, the fuel cell 350 according to the present embodiment does not require any particular attention to the direction of its installation.

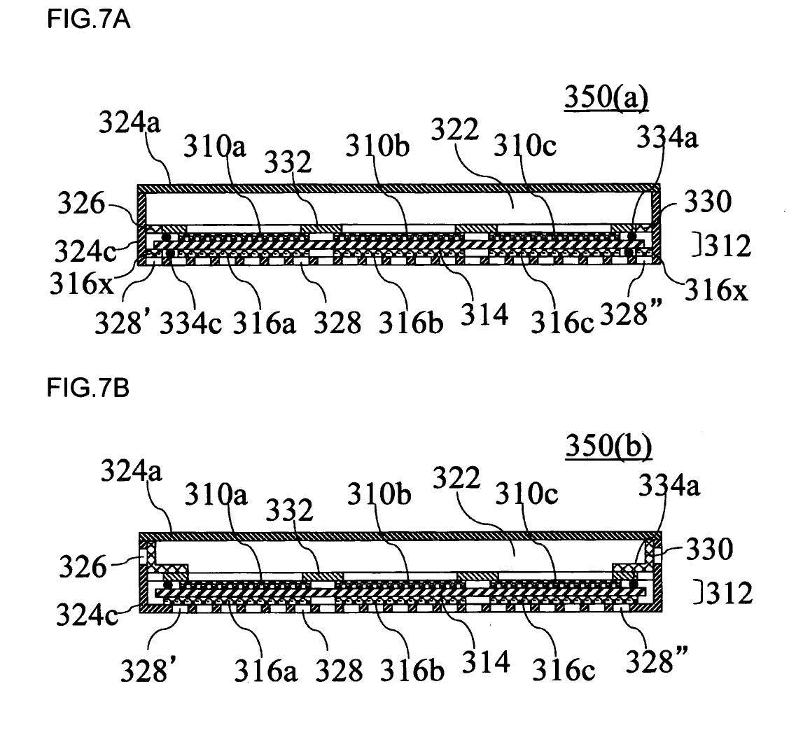

As modifications of the fuel cell 350, there may be structures of a fuel cell 350(a) and a fuel cell 350(b) shown in FIG. 7A and FIG. 7B, respectively. In the case of the fuel cell 350(a), the discharge paths of gaseous components arising from the anodes 310, such as the cathode-side product holes 328′ and 328″, are filled with the same material 316x as that for the cathodes 316 (a mixture of Pt black and a 5 wt % solution of DuPont's Nafion). Anode-side product discharge holes 326 are not provided in the side of the casing 324, and the anode-side product discharge holes 326 provided in the support member 332 are provided with a gas-liquid separation filter 330. Thus, the gaseous components, such as carbon dioxide, generated from the anodes 310 are selectively discharged while the liquid components, such as the methanol fuel are held in the fuel chamber 322. In the case of the fuel cell 350(b), the cathode-side O-ring 334c is not provided, and the peripheral cathodes 316 (316a and 316c here) are made larger than the anodes 310 provided countered thereto. As with the fuel cell 350(a), anode-side product discharge holes 326 are not provided in the side of the casing 324, and the anode-side product discharge holes 326 provided in the support member 332 are provided with a gas-liquid separation filter 330. Thus, the gaseous components, such as carbon dioxide, generated from the anodes 310 are selectively discharged while the liquid components, such as the methanol fuel are held in the fuel chamber 322. The structures such as those of the fuel cell 350(a) and the fuel cell 350(b) can reduce the number of materials or parts comprising the fuel cell 350, thus making it possible to offer the fuel cell 350 at lower cost.

### EXAMPLE 4 OF THE FIRST EMBODIMENT

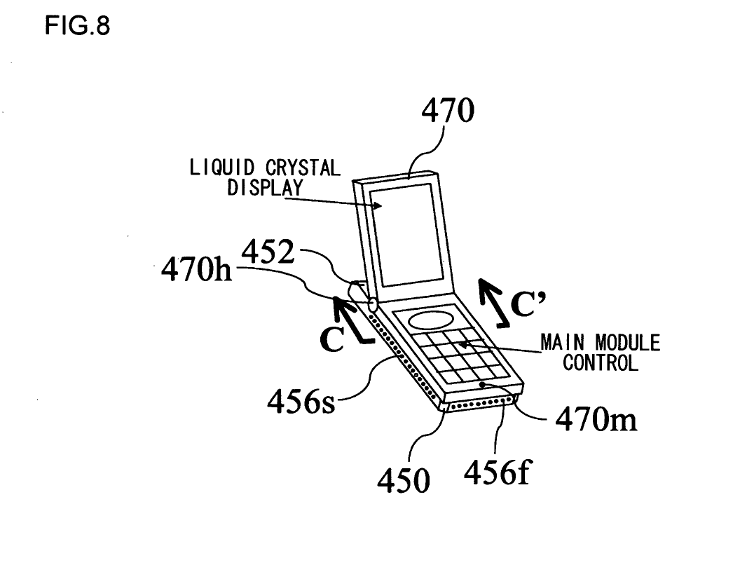

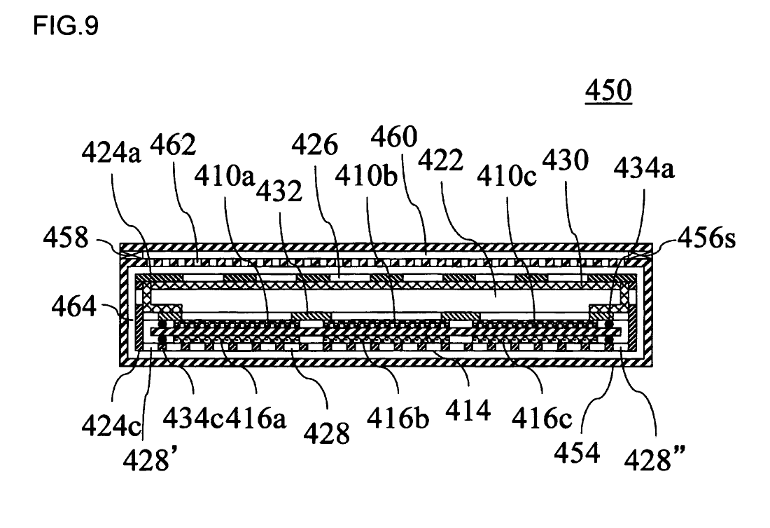

FIG. 8 is a perspective view schematically illustrating an appearance of a fuel cell 450 according to the present embodiment as applied to a mobile phone 470. In this Example, a methanol fuel to be supplied to anodes 410 is fed to a fuel chamber 422 through a methanol fuel feeding hole 420 from a fuel cartridge 452 provided on one side of the fuel cell 450. Shown in this appearance perspective view of FIG. 8 is a housing 454 which constitutes a fuel cell 450 according to Example 4. And as shown in FIG. 9, the body part of the fuel cell 450 provided in the housing 454 has the same structure as that of the fuel cell 150 of Example 1. Therefore, the description of the internal structure of the body part of the fuel cell 450 is omitted. It is to be noted, however, that this body part is not limited to the fuel cell 150 of Example 1, and it may be the fuel cell of Example 2 or Example 3. Furthermore, it may even be one different from any fuel cell of the present invention.

FIG. 9 is a cross-sectional view, taken along the line C-C′ of FIG. 8, which schematically illustrates an internal structure of a fuel cell 450 according to Example 4. A characteristic feature of this Example is such that an opening 456s is provided in the side of the housing 454 and an air feeding pump 458 is disposed inside the opening 456s. The air feeding pump 458 leads the air from outside the fuel cell 450 (housing 454) into the fuel cell 450. The air thus taken in by the air feeding pump 458 is led through an air passage 460 and an air passage hole 462 in this order and into an air passage 464 provided in the gap between the casing 424 and the housing 454. The air led into an air passage 464 is supplied to cathodes 416 through cathode-side product discharge holes 428, and the reaction products discharged from the cathodes 416 are passed through cathode-side product discharge holes 428 and the air passage 464 and discharged outside the fuel cell 450 (housing 454) through an opening 456f.

In other words, an air feeding pump 458, if provided, can create the flow of air (oxidant) in a predetermined direction as in the order of the opening 456s, the air passage 460, the air passage hole 462, the air passage 464, the cathode-side product discharge holes 428, the cathodes 416, the cathode-side product discharge holes 428, the air passage 464, and the opening 456f. The reaction products discharged from the anodes 410 are sent through the anode-side product discharge holes 426 and the cathode-side product discharge holes 428′ and then discharged together with air from the opening 456f. Thus, the creation of a fluid flow in a predetermined direction around the body part of the fuel cell 450 smoothens the suction of the oxidant or the exhaust of the reaction products. Furthermore, since a fluid (heat medium) flow is created around the casing 424, it is also possible to gain an effect of cooling the fuel chamber 422 by using a material with excellent thermal conductivity for the casing 424 (the anode-side casing 424a in particular).

The fuel cell 450 in FIG. 8 has a fuel cartridge 452 located close to a hinge 470h of the mobile phone 470 in order to assure the balance of the mobile phone 470. However, the location of the fuel cartridge 452 is not limited thereto, and it may instead be located in the neighborhood of a microphone 470m. In such a case, the opening 456f as shown in FIG. 8 is provided in the side of the housing 454 near the hinge 470h, and the reaction products from the anodes 410 and the cathodes 416 are discharged from a position farther from the microphone 470m (which can be close to the mouth of a person who may be using the mobile phone 470 now). In this manner, safety of the fuel cell may be ensured by reducing the effects of the reaction products on the human body.

### Second Embodiment

### Related Art to the Second Embodiment

The carbon dioxide is produced in the anode of DMFC. If this carbon dioxide is mixed into the methanol aqueous solution which is the fuel, as the carbonate ion or gas, a problem will be caused where the supply of fuel to the anode electrode is blocked. For such problems, various countermeasures are taken. For example, Reference (2) (FIG. 2) discloses a structure where a gas-liquid separation film is provided on the surface counter to the anode of a fuel chamber provided adjacent to the anode substrate.

Related Art List

(2) Japanese Patent Application Laid-Open No. 2004-079506.

Since the produced gas tends to stay on the upper side in the vertical direction, the produced gas will accumulate in the fuel chamber depending on the direction, at which the fuel cell is placed, even if the gas-liquid separation film is provided on the surface counter to the anode of a fuel chamber. Once the produced gas stays on, the distribution of the liquid fuel is blocked by the produced gas, which in turn contributes to the instability in supply of fuel and overall operation of a fuel cell.

A second embodiment has been made in view of the foregoing circumstances and a general purpose thereof is to provide a technique by which to promptly discharge the gas produced in an anode electrode and improve operational stability of a fuel cell.

One mode of carrying out the second embodiment relates to a fuel cell. This fuel cell comprises: an electrolyte membrane; an anode electrode and a cathode electrode with the electrolyte membrane interposed therebetween; a fuel chamber which stores a liquid fuel supplied directly to the anode electrode; and a gas-liquid separation unit provided on a side of the fuel chamber.

According to this mode, in the event that the direction at which a fuel cell is positioned changes and the anode electrode faces downward, the gas produced in the anode electrode is promptly discharged via the gas-liquid separation unit provided on a side of the fuel chamber, thus improving operational stability of the fuel cell.

In the above mode, the gas-liquid separation unit may be water-repellent. Since the structure realized by employing this mode prevents the entrance surface of the gas-liquid separation unit from being blocked up by a liquid fuel, the permeation of the produced gas through the gas-liquid separation unit is facilitated and the produced gas within the fuel chamber is promptly discharged.

In the above mode, the gas-liquid separation unit may also serve as a sealing member for sealing the fuel chamber. According to this mode, the number of materials or parts comprising the fuel cell can be reduced so as to reduce the cost and at the same time the fuel cell can be made small-sized.

In the above mode, the gas-liquid separation unit may be provided on an entire side of said fuel chamber. By implementing the structure according to this mode, the produced gas in the fuel chamber can be discharged efficiently from anywhere in the side the fuel chamber.

In the above mode, the gas-liquid separation unit may be partly provided on a side of a fuel chamber located in the vicinity of a place where gas produced in the anode electrode is likely to accumulate. By implementing the structure according to this mode, the produced gas which is likely to stay on at a specific location within the fuel chamber is discharged to a gas-liquid separation unit placed in the vicinity thereof. As a result, the discharge efficiency of the produced gas is improved.

### EXAMPLE 1 OF THE SECOND EMBODIMENT

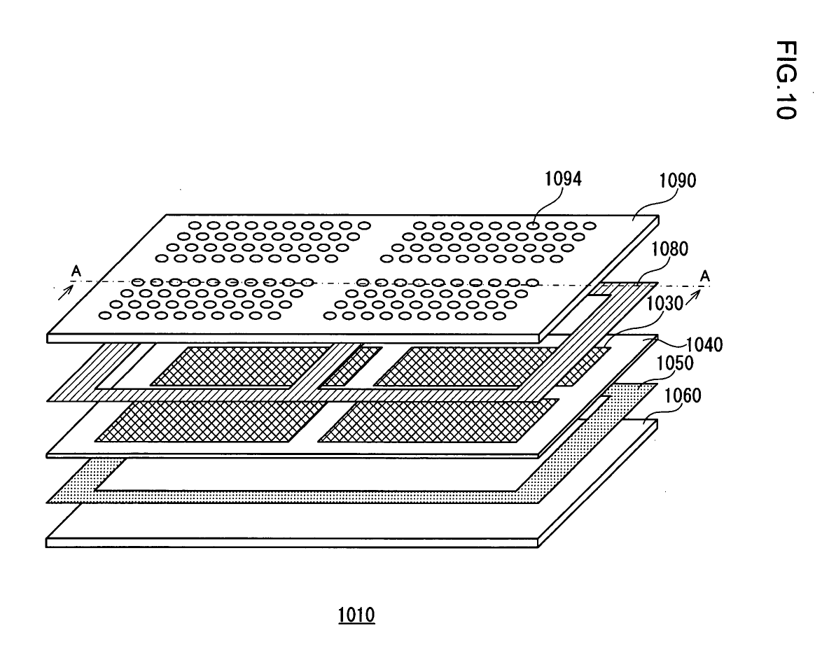

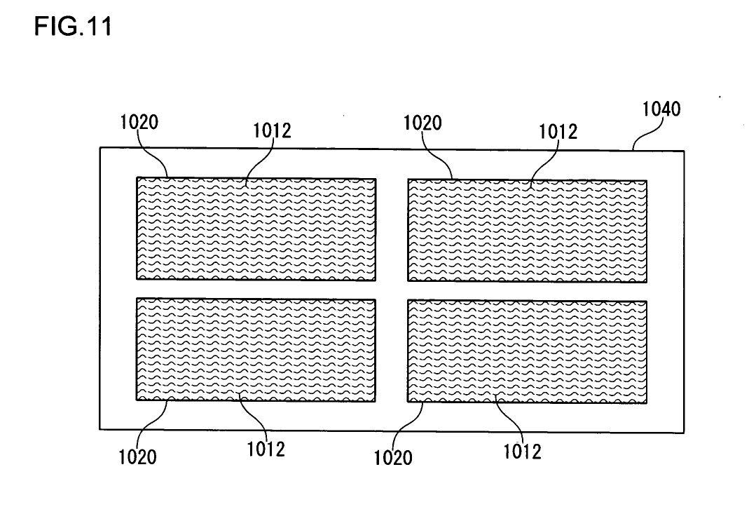

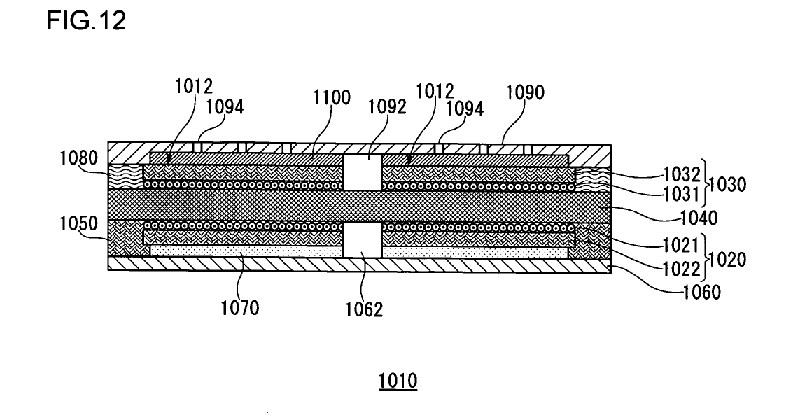

FIG. 10 is an exploded perspective view showing a DMFC 1010 according to Example 1 of a second embodiment. FIG. 11 illustrates a structure in an anode side of an electrolyte membrane 1040 according to Example 1 of the second embodiment. FIG. 12 is a cross-sectional view taken along the line A-A of FIG. 10.

A DMFC 1010 is comprised of a plurality of cells 1012 on a plane surface. Each cell 1012 is comprised of an anode electrode 1020, a cathode electrode 1030, and an electrolyte membrane interposed between the anode electrode 1020 and the cathode electrode 1030. A methanol aqueous solution or pure methanol (hereinafter referred to as “methanol fuel”) is supplied to the anode electrode 1020 by a capillary phenomenon. Air is supplied to the cathode electrode 1030. In the DMFC 1010, electricity is produced by an electrochemical reaction induced between methanol in the methanol fuel and oxygen in the air.

The anode electrode 1020 has an anode catalyst layer 1021 and an anode substrate 1022. The anode catalyst layer 1021 is joined with the electrolyte membrane 1040. The anode substrate 1022 is formed of porous material. The methanol fuel having passed through the anode substrate 1022 as a result of the capillary phenomenon is supplied to the anode catalyst 1021. A conductive material having a hydrophilic property is preferred for the anode substrate 1022. What is meant by “hydrophilic property” here is the property in which material is fit to the liquid fuel; and in more detail it is the property that the critical surface tension calculated by the Zisman plot is higher than the surface tension of liquid fuel. For example, the conductive material of hydrophilic property includes carbon paper, carbon felt, carbon cloth and those which underwent the hydrophilic coating, and the material where uniform microscopic pores are provided by performing etching on a sheet of titanium alloys or stainless alloys and those are subjected to the corrosion-resistant conductive coating (e.g., precious metal like gold and platinum).

An anode-side gasket 1050 is provided in the periphery of the electrolyte membrane 1040 in the side of the anode electrode 1020. An anode-side housing 1060 is placed on the anode-side gasket 1050, and a fuel chamber 1070 for storing a methanol fuel is formed by the anode electrode 1020, the anode-side gasket 1050 and the anode-side housing 1060. The methanol fuel stored in the fuel chamber 1070 is supplied directly to the anode electrode 1020. A detailed description of the anode-side gasket 1050 will be given later. A rib 1062 is provided in the anode-side housing 1060. The anode electrode 1020 in each cell 1012 is separated by the rib 1062. It is desirable that the anode-side housing 1060 fulfill the characteristics of methanol resistance, acid resistance, mechanical rigidity and the like. It is also desirable that the anode-side housing 1060 be of hydrophilic nature. Note that the anode-side housing 1060 has a not-shown fuel suction unit which absorbs the methanol fuel from a not-shown fuel tank provided external to the DMFC 1010 and the methanol fuel is refilled into the fuel chamber 1070 when necessary.

The material that forms the anode-side housing 1060 includes such metal material as stainless metal and titanium alloy as well as a certain variety of synthetic resins, such as acrylic resin, epoxy resin, glass-epoxy resin, silicon resin, cellulose, nylon, polyamide-imide, polyallylamide, polyallyl ether ketone, polyimide, polyurethane, polyetherimide, polyether ether ketone, polyether ketone ether ketone ketone, polyether ketone ketone, polyether sulfone, polyethylene, polyethylene glycol, polyethylene terephthalate, polyvinyl chloride, polyoxymethylene, polycarbonate, polyglycolic acid, polydimethylsiloxane, polystyrene, polysulfone, polyvinyl alcohol, polyvinyl pyrrolidone, polyphenylene sulfide, polyphthalamide, polybutylene terephthalate, polypropylene, polytetrafluoroethylene, and rigid polyvinyl chloride.

On the other hand, the cathode electrode 1030 has a cathode catalyst layer 1031 and a cathode substrate 1032. The cathode catalyst layer 1031 is joined with the electrolyte membrane 1040. The cathode substrate 1032 is formed of a material allowing air pass through easily. The air having passed through the cathode substrate 1032 is supplied to the cathode catalyst layer 1031.

A cathode-side gasket 1080 is provided in the periphery of the electrolyte membrane 1040 in the side of the cathode electrode 1030. An cathode-side housing 1090 is placed on the anode-side gasket 1080. A rib 1092 is provided in the cathode-side housing 1090. The cathode electrode 1030 in each cell 1012 is separated by the rib 1092. An air introducing hole 1094 for intake of air is provided in the cathode-side housing 1090. The air flowing from the air introducing hole 1094 flows into an air chamber 1100 comprised of the cathode electrode 1030, the cathode-side gasket 1080 and the cathode-side housing 1090, so as to reach the cathode substrate 1032. The rib 1092 is provided in the cathode-side housing 1090. The cathode electrode 1030 in each cell 1012 is separated by the rib 1092. It is desired that the cathode-side housing 1090 be water-repellent. As a material forming the cathode-side housing 1090, the material exemplified above for the anode-side housing 1060 may be used.

For each cell 1012, a current collector (not shown) is each provided on the surface of the anode substrate 1022 and the cathode substrate 1032. And each cell is electrically connected in series using a wire (not shown).

A description is now given of the anode-side gasket 1050. The anode-side gasket 1050 according to this example is such that the whole gasket 1050 is formed of gas-liquid separation filters. The gas-liquid separation filter has a gas-liquid separation function of having the gas produced in the anode penetrate but having the methanol fuel shut off. As a material that expresses the gas-liquid separation function, there is a woven fabric, nonwoven fabric, mesh, felt, or porous material like sponge having open pores.

The composition constituting the porous material includes polytetrafluoroethylene (PTFE), tetrafluoroethylene-perfluoroalkylvinylether copolymer (PFA), tetrafluoroethylene-hexafluoropropylene copolymer (FEP), tetrafluoroethylene-ethylene copolymer (ETFE), polyvinylidene fluoride (PVDF), polychlorotrifluoroethylene (PCTFE), chlorotrifluoroethylene-ethylene copolymer (E/CTFE), polyvinyl fluoride (PVF), and perfluoro ring polymer.

The gas-liquid separation filter is preferably water-repellent. Here, being water repellent is a property where the liquid fuel is repelled and, in more detail, a property that the critical surface tension calculated by Zisman plot is lower than the surface tension of liquid fuel. Table 1 illustrates a relation between the methanol concentration and the surface tension.

TABLE 1

| Methanol concentration (wt %) | Surface tension (10⁻³ N/m) |
|---|---|
| 0 | 72.0 |
| 5 | 61.4 |
| 13 | 52.5 |
| 17 | 49.1 |
| 33 | 39.3 |
| 43 | 35.2 |
| 72 | 28.1 |
| 82 | 25.9 |
| 100 | 22.1 |

TABLE 2

| Resin material | Critical surface tension (10⁻³ N/m) |
|---|---|
| Teflon | 18.0 |
| Polyethylene | 31.0 |
| Polystyrene | 33.0 |

As shown in Table 1 and Table 2, Teflon (registered trademark) is water-repellent with respect to the methanol fuel having any of methanol concentration. If the methanol concentration is at least 72% weight or more, polyethylene and polystyrene will be water-repellent with respect to the methanol fuel. Accordingly, Teflon is preferred as a composition constituting the porous material.

The water-repellent property is provided for the gas-liquid separation filter, so that the structure realized thereby prevents the entrance surface of the gas-liquid separation filter from being blocked up by a liquid fuel. Hence, the permeation of the produced gas through the gas-liquid separation filter is facilitated and the produced gas within the fuel chamber 1070 is promptly discharged.

According to the DMFC 1010 of the present embodiment, in the event that the direction at which the DMFC 1010 is positioned changes and the anode electrode 1020 faces downward, the gas produced in the anode electrode is promptly discharged through the gas-liquid separation filter provided in the anode-side gasket 1050 provided in the periphery of the anode electrode 1020, thus improving operational stability of the fuel cell.

### EXAMPLE 2 OF THE SECOND EMBODIMENT

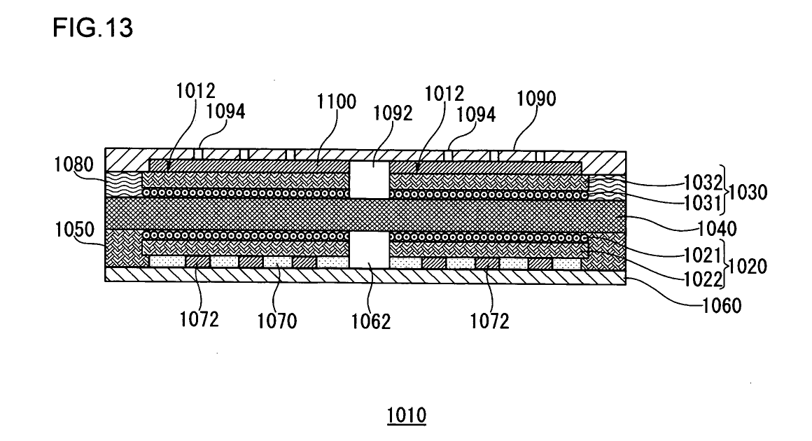

FIG. 13 is a cross-sectional view showing a structure of a DMFC 1010 according to Example 2 of the second embodiment. The basic structure of the DMFC 1010 according to this Example 2 of the second embodiment is the same as the structure of Example 1 of the second embodiment. Hereinbelow, a distinguishing structure of Example 2 of the second embodiment will be described. As shown in FIG. 13, a spacer 1072 is provided in a fuel chamber 1070.

With the provision of the spacer 1072, a distance is kept between an anode electrode 1020 and an anode-side housing 1060. Also, with the provision of the spacer 1072, the anode electrode 1020 is pressed against an electrolyte membrane 1040, thus improving the degree of contact and adhesion between the anode electrode 1020 and the electrolyte membrane 1040.

It is desirable that the spacer 1072 provided within the fuel chamber 1070 fulfill the characteristics of methanol resistance, acid resistance, mechanical rigidity and the like. In the case where the spacer 1072 is of such a shape as to divide the anode electrode 1020, it is desirable that the produced gas can pass through the spacer 1072, and a porous material may be used for the spacer 1072. For example, in addition to the same porous material as the above-described gas-liquid filter, the material used for the spacer 1072 includes a woven fabric, nonwoven fabric, or felt made of such fibers as polyethylene, nylon, polyester, rayon, cotton, polyester/rayon, polyester/acryl, or rayon/polychlal and an inorganic solid, such as boron nitride, silicon nitride, tantalum carbide, silicon carbide, sepiolite, attapulgite, zeolite, silicon oxide and titanium oxide.

### EXAMPLE 3 OF THE SECOND EMBODIMENT

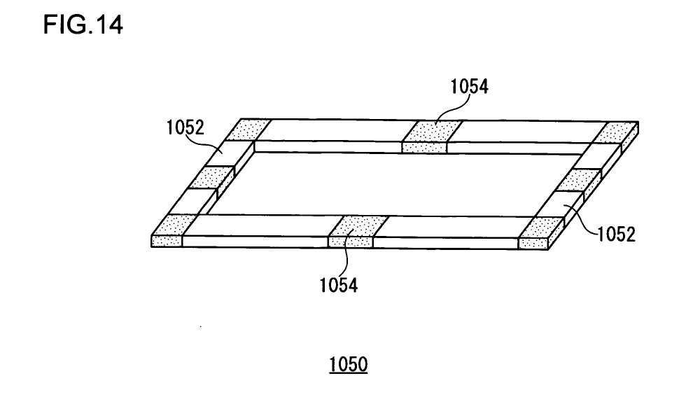

The basic structure of a DMFC according to this Example 3 of the second embodiment is the same as the structure of Example 1 of the second embodiment. Hereinbelow, a distinguishing structure of Example 3 of the second embodiment will be described. FIG. 14 is a perspective view of an anode-side gasket 1050 used in Example 3 of the second embodiment. The anode-side gasket 1050 used in this example is comprised, in part, of a gas-liquid separation filter. That is, the anode-side gasket 1050 is comprised of gas-liquid separation parts 1052 and dense parts 1054. The anode-side gasket 1050 according to Example 3 of the second embodiment is obtained as follows. The dispersion of Teflon is selectively applied repeatedly to and impregnated with a frame-like sheet formed of a porous material such as polyflon paper (trademark registered by Daikin Industries, Inc.), polyflonweb (trademark registered by Daikin Industries, Inc.) or micro-tex (trademark registered by Nitto Denko Co., Inc.), so as to partly densify the porous material.

The swelling and expansion/contraction are caused in a part coming in contact with the methanol as a result of the electric power generation cycles of the DMFC 1010. This then leads to a deviation in the tightening dimensions for the anode-side housing 1060, the anode electrode 1020 and the electrolyte membrane 1040. The tightening in the DMFC 1010 is stabilized by tightening the anode electrode 1020 and the electrolyte membrane 1040 by way of the dense parts 1054 provided partially in the anode-side gasket 1050. Hence, the increase in resistance in the fuel cell can be suppressed and at the same time the fuel leakage can be suppressed.

### EXAMPLE 4 OF THE SECOND EMBODIMENT

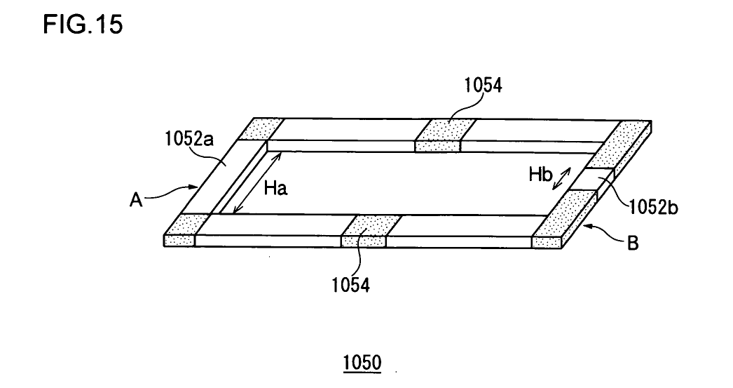

The basic structure of a DMFC according to this Example 4 of the second embodiment is the same as the structure of Example 1 of the second embodiment. Hereinbelow, a distinguishing structure of Example 4 of the second embodiment will be described. FIG. 15 is a perspective view of an anode-side gasket 1050 used in Example 4 of the second embodiment. Example 4 of the second embodiment is similar to Example 3 of the second embodiment in that the anode-side gasket 1050 used in Example 4 is comprised, in part, of a gas-liquid separation filter. In the anode-side gasket used in Example 4 of the second embodiment, the component ratio of the gas-liquid separation part 1052 and the dense part 1054 differs in sides counter to each other. More specifically, the opening length Ha of the gas-liquid separation part 1052a in the side A is larger than the opening length Hb of the gas-liquid separation part 1052b in the side B. Depending on the status of electric power generation in a DMFC or the status of use in equipment to which the DMFC is installed, there may be cases where the amount of produced gas in the anode electrode 1020 is unevenly distributed. In such a case, the opening length of the gas-liquid separation part 1052 located nearer to an area where the amount of produced gas is large is set to a relatively longer length, so that the produced gas can be discharged efficiently from the DMFC.

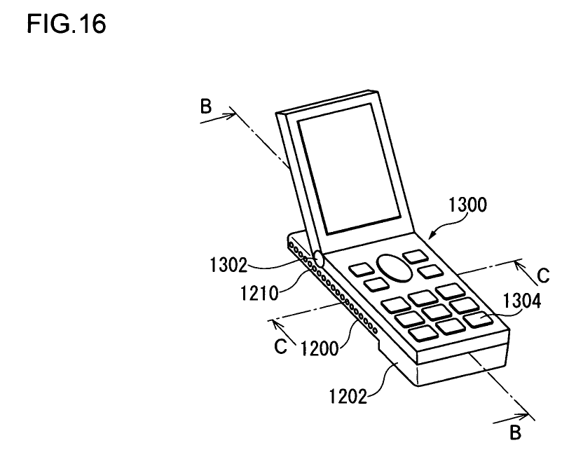

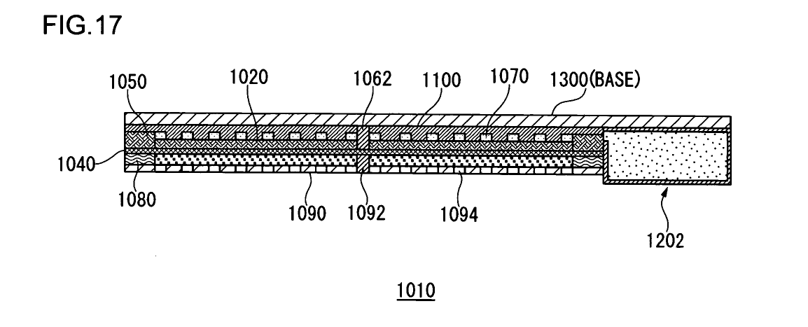

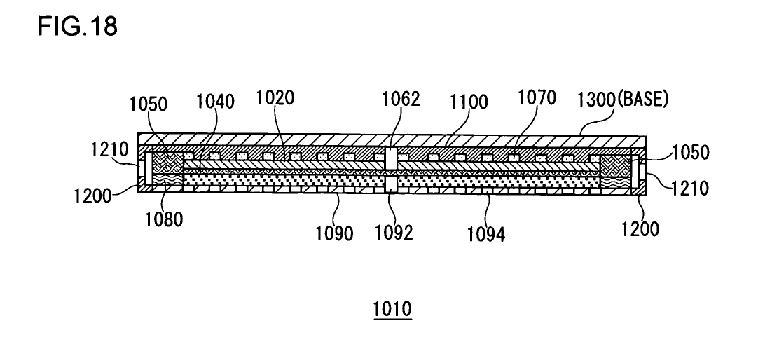

FIG. 16 illustrates an example where a DMFC according to Example 4 of the second embodiment is placed on the back face of a fold-type mobile phone. FIG. 17 is a cross-sectional view taken along the line B-B of FIG. 16, and FIG. 18 is a cross-sectional view taken along the line C-C of FIG. 16. The DMFC 1010 is placed in a manner that the anode electrode thereof faces a mobile phone 1300. A fuel cartridge 1202 and a fuel chamber 1070 are communicated with each other by way of a fuel feeding path (not shown). As the remaining quantity of methanol fuel in the fuel chamber 1070 gets low, the methanol fuel is refilled into the fuel chamber 1070 from a fuel cartridge 1202 as appropriate. After the gas produced in the anode electrode 1020 passes through the gas-liquid separation part built in the anode-side gasket 1050, it is discharged to the outside by way of an opening 1210 provided in the side of a casing 1200 for DMFC.

At the time of operation such as being engaged in telephone call, the Internet and electronic mail, the position of a mobile phone is such that a hinge 1302 is above a main module control 1304 in the vertical direction and at the time of electric power generation the gas produced in the anode electrode 1020 moves to the hinge side. In this case, if the side A in FIG. 15 is placed on the hinge side, the produced gas can be discharged more efficiently from the gas-liquid separation part 1052 in the hinge side. As a result, the supply of methanol fuel is less likely to be blocked by the produced gas, so that the DMFC 1010 can generate the electric power appropriate for the power consumption of the mobile phone 1300.

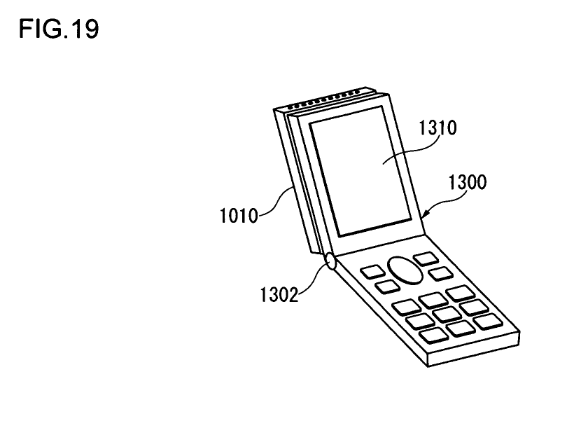

In FIG. 19, a DMFC 1010 is placed on the backside of an LCD (Liquid Crystal Display) 1310 of a mobile phone 1310. In this case, at the time of operation of the mobile phone 1310 the upper part of the LCD 1310 is positioned above a hinge 1302 in the vertical direction and at the time of electric power generation the gas produced in the anode electrode the DMFC moves to the upper part of the LCD 1310. In this case, if the side A in FIG. 15 is placed on the upper side of the LCD 1310, the produced gas can be discharged more efficiently from a gas-liquid separation part 1052a provided in the upper side of the LCD 1310. As a result, the supply of methanol fuel is less likely to be blocked by the produced gas, so that the DMFC 1010 can generate the electric power appropriate for the power consumption of the mobile phone.

The present invention is not limited to the above-described embodiments and examples only, and it is understood by those skilled in the art that various modifications such as changes in design may be made based on their knowledge and the embodiments and examples added with such modifications are also within the scope of the present invention.

### INDUSTRIAL APPLICABILITY

The embodiments and the examples may be used not only for a DMFC but also for a fuel cell for mobile equipment. They are useful particularly for a type of fuel cell where materials differing greatly in specific gravity (density) move in and out through electrodes in a manner that the liquid is supplied as a fuel to be supplied to an anode or oxidant to be supplied to a cathode and the gaseous matter is discharged from the anode or cathode as their reaction products.

What is claimed is:

1. A fuel cell, comprising:
an electrolyte layer;
a first electrode, provided on a first main surface of said electrolyte layer, in which a first liquid reaction fluid is supplied and a first gaseous reaction product is produced;
a second electrode, provided on a second main surface of said electrolyte layer, in which a second reaction fluid is supplied;
a casing which houses said electrolyte layer, said first electrode and said second electrode;
a first reaction product fluid discharge opening, provided in said casing, which discharges the first reaction product from said first electrode; and
a second reaction fluid feed opening, provided in said casing, which supplies the second fluid reaction fluid to said second electrode,
wherein said first reaction product discharge opening is provided on at least two surfaces of said casing.

2. A fuel cell, comprising:
an electrolyte layer;
a first electrode, provided on a first main surface of said electrolyte layer, in which a first liquid reaction fluid is supplied and a first gaseous reaction product is produced;
a second electrode, provided on a second main surface of said electrolyte layer, in which a second reaction fluid is supplied;
a casing which houses said electrolyte layer, said first electrode and said second electrode;
a first reaction product fluid discharge opening, provided in said casing, which discharges the first reaction product from said first electrode; and
a second reaction fluid feed opening, provided in said casing, which supplies the second fluid reaction fluid to said second electrode,
wherein said first reaction product discharge opening is provided on a surface on which said second reaction fluid feed opening is provided.

3. A fuel cell according to claim 1, wherein a material having a gaseous component passed and having a liquid component not passed is placed in said first reaction product discharge opening.

4. A fuel cell according to claim 2, wherein a material having gas permeability and liquid impermeability is placed in said first reaction product discharge opening.

5. A fuel cell according to claim 1, further comprising a first reaction fluid chamber which holds the first reaction fluid, wherein at least two surfaces countered to each other have an approximately parallel form.

6. A fuel cell according to claim 2, further comprising a first reaction fluid chamber which holds the first reaction fluid, wherein at least two surfaces countered to each other have an approximately parallel form.

7. A fuel cell according to claim 5, wherein there is provided a recess in one of the at least two surfaces of said first reaction fluid chamber, and the recess houses said first electrode and said second electrode, and
wherein one of the surfaces of said first reaction fluid chamber and a surface, on which said second reaction fluid feed opening in said casing is provided, form an identical surface.

8. A fuel cell according to claim 6, wherein there is provided a recess in one of the at least two surfaces of said first reaction fluid chamber, and the recess houses said first electrode and said second electrode, and
wherein one of the surfaces of said first reaction fluid chamber and a surface, on which said second reaction fluid feed opening in said casing is provided, form an identical surface.

9. A fuel cell, comprising:
an electrolyte membrane;
an anode electrode and a cathode electrode with said electrolyte membrane interposed therebetween;
a fuel chamber which stores a liquid fuel supplied directly to said anode electrode; and
a gas-liquid separation unit provided on a side of said fuel chamber.

10. A fuel cell according to claim 9, wherein said gas-liquid separation unit is water-repellent.

11. A fuel cell according to claim 9, wherein said gas-liquid separation unit serves additionally as a sealing member for sealing said fuel chamber.

12. A fuel cell according to claim 9, wherein the gas-liquid separation unit may be provided on an entire side of said fuel chamber.

13. A fuel cell according to claim 9, wherein said gas-liquid separation unit is partly provided on a side of a fuel chamber located in the vicinity of a place where gas produced in said anode electrode is likely to accumulate.
